(19) United States
(12) Patent Application Publication
(10) Pub. No.: US 2008/0056417 A1
(43) Pub. Date: Mar. 6, 2008

(54) Integrated television tuner

(75) Inventors: Shao-Hua Chen, Hsinchu (TW); Hsien-Cheng Chen, Hsinchu (TW); Tung-Ming Su, Hsinchu (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: CHEERTEK INC.

(21) Appl. No.: 11/790,079

(22) Filed: Apr. 23, 2007

(30) Foreign Application Priority Data
Aug. 18, 2006 (TW) 095130356

(51) Int. Cl. H04B 1/10

(52) U.S. Cl. 375/350; 375/E07.015

(57) ABSTRACT

An integrated television tuner, which enhances image rejection by employing a filter device between the first mixing and the second mixing operations in a dual-conversion architecture. Signal selectivity is improved and linearity requirement on following stages is reduced.

### BACKGROUND OF THE INVENTION

1. Field of the Invention

The present invention relates to a television tuner, and more particularly to an integrated television tuner with a filter device to filter or attenuate a mirror image signal, so as to improve selectivity of the desired signal.

2. Description of the Related Art

It is common to use a tuner to convert a radio frequency (RF) signal (50˜860 MHz) to a lower frequency signal, and to select a channel that occupies a certain frequency span (channel bandwidth) around a specific frequency, from the entire spectrum. The frequency conversion is performed by a mixing technique. In this mixing technique, an input signal (herein called the ‘RF’ signal) is mixed with a local (‘LO’) signal to produce a signal (the ‘F’ signal) whose frequency is the difference of the RF and LO signal frequencies. That is,
f_{IF}=|f_{RF}−f_{LO}|
where f_{IF}, f_{RF} and f_{LO} are IF, RF and LO signal frequencies, respectively. The mixing also produces higher frequency by-products that are routinely filtered out using low-pass filters. Therefore, these higher frequency by-products are not considered unless the situation demands otherwise. In conventional mixing, an image signal problem occurs. Without loss of generality, assume f_{RF}>f_{LO}>f_{IF}=f_{RF}−f_{LO}. If another signal at frequency f_{LO}−f_{IF} (=f_{RF}−2f_{IF}) is present at the input of the mixer, it will also produce an output signal at frequency f_{IF}. Since this output signal is at the same frequency as the desired IF signal, conventional filtering by frequency differentiation can not separate them from each other. If circuit elements following the mixer cannot separate the desired IF signal from the undesired IF signal, the received signal is contaminated and its quality is degraded. The RF signal at frequency f_{LO}−f_{IF} is called the RF image. The IF signal produced by the RF image is called the IF image. Sometimes the RF image and the IF image are both referred to as the ‘image’ without distinction. The RF image frequency is separated from the desired signal RF frequency by 2f_{IF}.

A conventional method uses a quadrature mixer to facilitate the circuit elements following the mixer to separate the desired IF signal from the IF image. Refer to FIG. 1 for a schematic block diagram showing a conventional television tuner using a quadrature mixer. As shown in the figure, two signals with the same frequency and 90° phase difference, are used as a local signal. The RF signal is respectively mixed with the two local signals (by using two mixers) to generate an in-phase IF signal (I) and a quadrature-phase IF signal (Q). A specific relationship exists between the in-phase IF signal (I) and the quadrature-phase IF signal (Q). Note that the RF image signal also mixes with the local signals to produce the in-phase IF image signal (I′) and quadrature-phase IF image signal (Q). However, the phase relationship between the image I′ and Q′ signals, is different from the phase relationship between the desired I and Q signals. Specifically, Q may be 90° in phase behind I, whereas Q′ is 90‘ahead of I’, or vice versa. Thus, it is possible to separate I and Q from I′ and Q′ by exploiting this difference (for example, by using a polyphase filter).

In addition, the approved ROC Patent No. 1249348 disclosed a television tuner structure using a dual-conversion architecture. Refer to FIG. 2, which schematically shows a conventional dual-conversion architecture according to ROC Patent No. 1249348. In the dual-conversion architecture, the desired RF signal is converted twice before it reaches the final frequency. Note that since frequency conversion or mixing is performed twice, the problem of image signal also happens twice. The RF image of the first conversion, however, can be well separated from the RF signal (for example, by over several hundred megahertz) if the IF frequency of the first conversion is chosen to be high enough, as in the Prior Art of ROC Patent No. 1249348. The RF image of the first conversion can therefore be precluded by filtering at the tuner input. Also note that in this architecture, four mixers are required in the second mixing stage.

Refer to FIG. 3, which shows the RF and IF signals of concern on the frequency axis, for each node (A, B, B′, C and D) of the dual-conversion architecture in FIG. 2. In the figures, the RF and IF images of the first conversion are assumed to be filtered out as described above and are not shown. In FIG. 3, signals ‘2’ and ‘3’ are the desired RF signals to be received. Signals ‘1’ and ‘4’ are undesired signals that are 2f_{IF2} apart from signals ‘2’ and ‘3’ in frequency and appear as RF images in the second conversion. After the second conversion, signals ‘1’ and ‘4’ are respectively overlaid with signals ‘3’ and ‘2’. (See spectrum C in the figure). Ideally, signals ‘1’ and ‘4’ have different phase relationships from signals ‘2’ and ‘3’. By utilizing this phase relationship difference, signals ‘1’ and ‘4’ can be totally removed by a polyphase filter whereas signals ‘2’ and ‘3’ are retained (see spectra C and D). However, such complete removal relies on the condition of perfect match between in-phase and quadrature-phase signals. In spectrum C the top spectra are the in-phase components (‘I’) and the bottom spectra are the quadrature-phase components (‘Q’). The ‘I’ and ‘Q’ signals must have exactly the same amplitude and their phase difference must be exactly 90° apart for the polyphase filter to achieve perfect image signal removal. If the ‘I’ and ‘Q’ signals are not perfectly matched, for example, their amplitudes are not equal or their phase difference is not exactly 90°, signals ‘1’ and ‘4’ will not be completely removed, and residual mirror image signals mixes with the received signal. The suppression of the mirror image signal (i.e. signals ‘1’ and ‘4’) from RF to IF output is gauged by a metric called the image-rejection ratio (IRR or IMRR). When the dual-conversion architecture is implemented in an integrated circuit (IC) form, the matching precision is restricted by the IC manufacturing condition, and an IRR of at most 50 to 55 dB may be reached. Unfortunately, such IRR values are not sufficient for television tuner applications, which usually require an IRR of at least 60 dB.

### SUMMARY OF THE INVENTION

Therefore, it is a primary objective of the present invention to provide an integrated television tuner, which provides enhanced suppression of image signals.

Another objective of the present invention is to provide an integrated television tuner with reduced linearity requirements of the second mixer and subsequent circuit elements, so as to reduce the manufacturing cost.

To achieve the foregoing objectives, the integrated television tuner of the present invention comprises: a low noise amplifier (LNA) with an input terminal coupled to a radio frequency (RF) signal; a first local signal generation unit for generating a first local signal and a first quadrature local signal; a first mixer device with a mixer and a quadrature mixer, wherein the first input terminals of the mixer and the quadrature mixer are coupled to the output of the LNA, and the second input terminals are coupled to the first local signal generation unit for generating a first intermediate frequency (IF) signal and a first IF quadrature signal by mixing the RF signal from the LNA with the first local signal and the first quadrature local signal; a filter device with an input terminal coupled to an output of the first mixer device for respectively filtering or attenuating the first IF signal and the first IF quadrature signal; a second local signal generation unit for generating a second local signal and a second quadrature local signal; a second mixer device with the first input terminals coupled to the filter device and the second input terminals coupled to the second local signal generation unit for generating a second IF signal and a second IF quadrature signal by mixing the first IF signal and the first IF quadrature signal with the second local signal and the second quadrature local signal; a polyphase filter with an input terminal coupled to the second mixer device for combining the second IF signal and the second IF quadrature signal, so as to filter out the image signal and produce a single output signal; and a first variable gain amplifier (VGA) coupled to the complex channel select filter to amplify the selected channel signal.

To achieve the foregoing objectives, the integrated television tuner of the present invention comprises: a low noise amplifier (LNA) with an input terminal coupled to a radio frequency (RF) signal; a first local signal generation unit for generating a first local signal and a first quadrature local signal; a first mixer device with a mixer and a quadrature mixer, wherein the first input terminals of the mixer and the quadrature mixer are coupled to the output of the LNA, and the second input terminals are coupled to the first local signal generation unit for generating a first intermediate frequency (IF) signal and a first IF quadrature signal by mixing the RF signal with the first local signal and the first quadrature local signal; a filter device with an input terminal coupled to the output of the first mixer device for respectively filtering or attenuating the first IF signal and the first IF quadrature signal; a second local signal generation unit for generating a second local signal and a second quadrature local signal; a second mixer device with the first input terminals coupled to the filter device and the second input terminals coupled to the second local signal generation unit for generating a second IF signal and a second IF quadrature signal by mixing the first IF signal and the first IF quadrature signal with the second local signal and the second quadrature local signal; a complex channel select filter with an input terminal coupled to the second mixer device for respectively filtering the second IF signal and the second IF quadrature signal to select a predetermined channel signal and to filter other channel signals and the image signal, so as to produce a single output signal; and a first variable gain amplifier (VGA) coupled to the complex channel select filter to amplify the selected channel signal.

To achieve the foregoing objectives, the integrated television tuner of the present invention comprises: a first local signal generation unit for generating a first local signal and a first quadrature local signal; a first mixer device with a mixer and a quadrature mixer, wherein the first input terminals of the mixer and the quadrature mixer are coupled to the output of the LNA, and the second input terminals are coupled to the first local signal generation unit for generating a first intermediate frequency (IF) signal and a first IF quadrature signal by mixing the RF signal with the first local signal and the first quadrature local signal; a filter device with an input terminal coupled to the output of the first mixer device for respectively filtering or attenuating the first IF signal and the first IF quadrature signal; a second local signal generation unit for generating a second local signal and a second quadrature local signal; a second mixer device with the first input terminals coupled to the filter device and the second input terminals coupled to the second local signal generation unit for generating a second IF signal and a second IF quadrature signal by mixing the first IF signal and the first IF quadrature signal with the second local signal and the second quadrature local signal; and a polyphase filter with an input terminal coupled to the second mixer device for combining the second IF signal and the second IF quadrature signal, so as to filter out the image signal and produce a single output signal; and a first variable gain amplifier (VGA) coupled to the complex channel select filter to amplify the selected channel signal.

### BRIEF DESCRIPTION OF THE DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 is a schematic block diagram showing a conventional television tuner using a quadrature mixer.

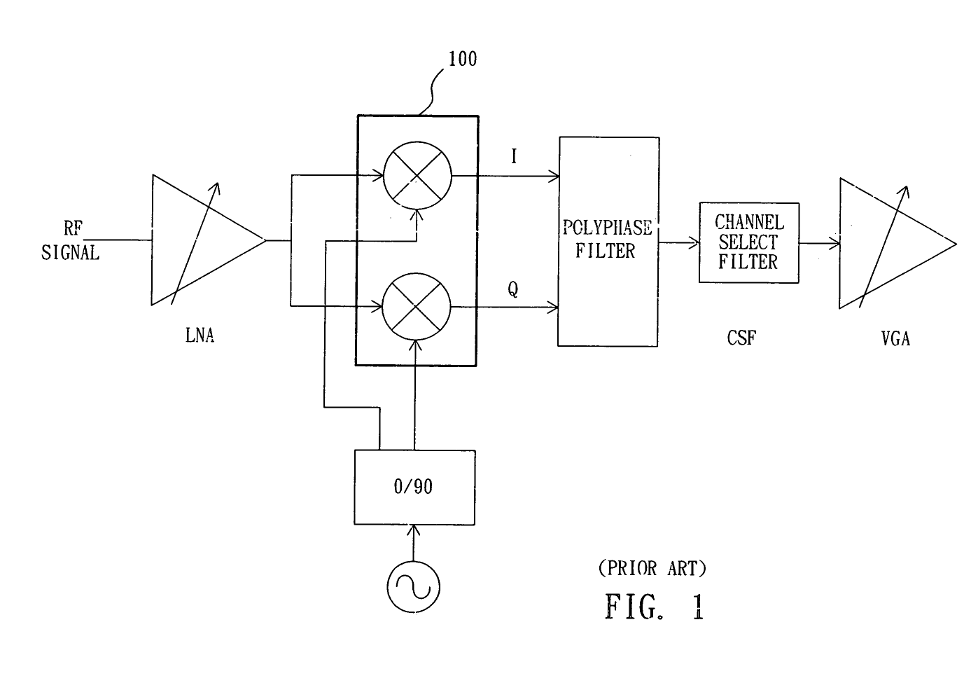

FIG. 2 is a schematic block diagram showing a conventional dual-conversion tuner according to ROC Patent No. 1249348.

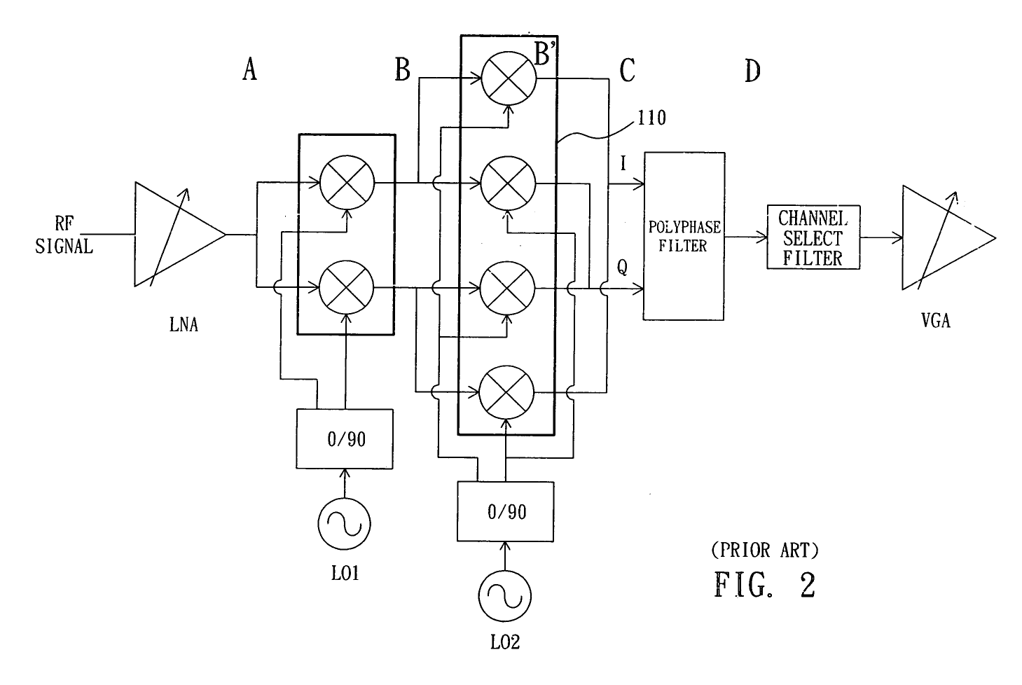

FIG. 3 shows the RF signals and the IF signals on the frequency axis after transformed by the dual-conversion tuner.

FIG. 4 is a schematic diagram showing an integrated television tuner according to a preferred embodiment of the present invention.

FIG. 5 is a schematic diagram showing an integrated television tuner according to another preferred embodiment of the present invention.

FIG. 6 is a schematic diagram showing an integrated television tuner according to yet another preferred embodiment of the present invention.

### DETAILED DESCRIPTION OF THE PREFERRED EMBODIMENTS

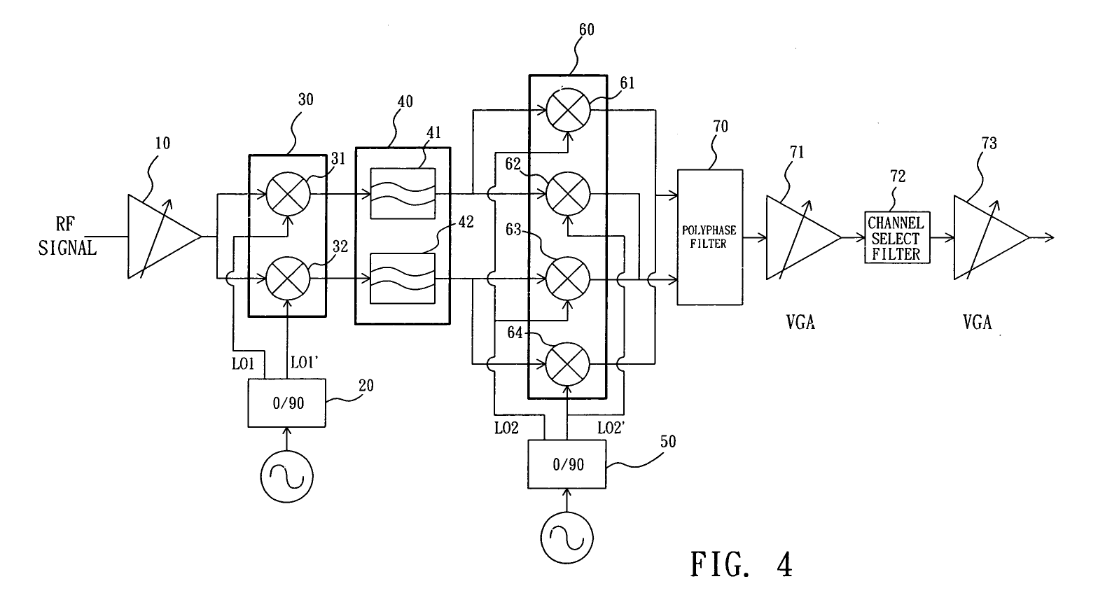

Refer to FIG. 4 for a schematic diagram showing an integrated television tuner according to a preferred embodiment of the present invention. The integrated television tuner of the present invention comprises: a low noise amplifier (LNA) 10; a first local signal generation unit 20; a first mixer device 30; a filter device 40; a second local signal generation unit 50; a second mixer device 60; and a polyphase filter 70.

Wherein, an input terminal of the low noise amplifier 10 is coupled to a RF signal to perform the low noise amplification on the RF signal.

The first local signal generation unit 20 generates a first local signal (LO1) and a first quadrature local signal (LO1′), wherein the first local signal (LO1) and the first quadrature local signal (LO1′) have the same amplitude and 90° phase difference.

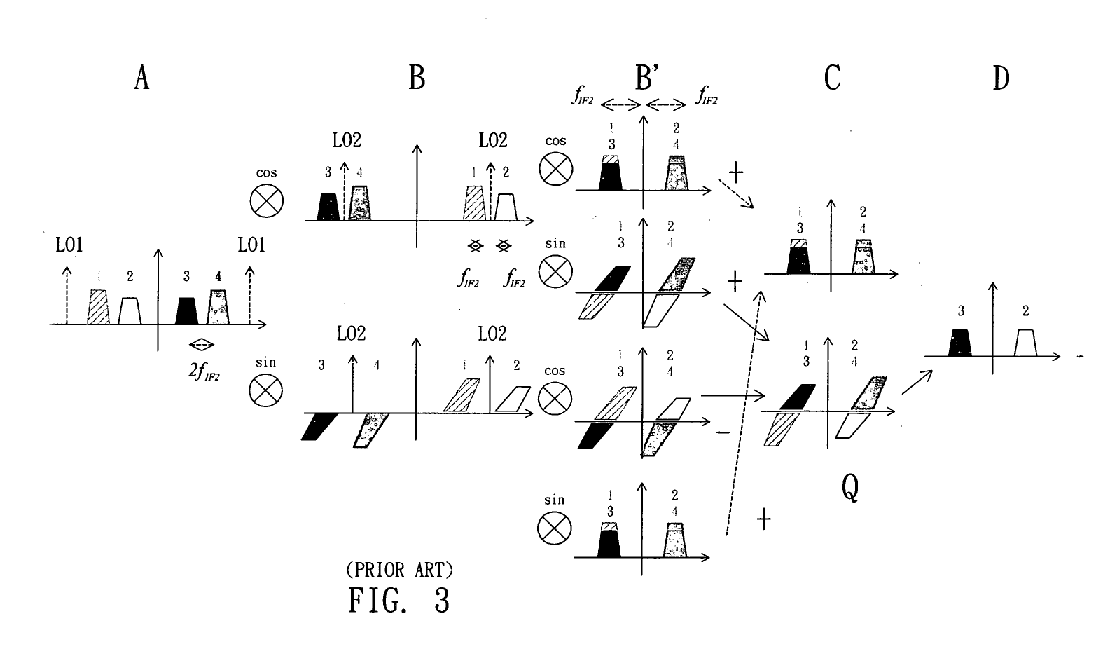

The first mixer device 30 comprises a first mixer 31 and a first quadrature mixer 32, wherein an input terminal of the first mixer 31 is coupled to the LNA, and another terminal is coupled to the first local signal of the first local signal generation unit 20; an input terminal of the first quadrature mixer 32 is coupled to the LNA, and another terminal is coupled to the first quadrature local signal of the first signal generation unit 20. The first mixer 31 mixes the LNA output signal with the first local signal to generate a first IF signal; and the first quadrature mixer 32 mixes the LNA output signal with the first quadrature local signal to generate a first IF quadrature signal. (Please refer to B of FIG. 3 for its spectrum.)

The present invention is mainly characterized in the filter device 40. An input terminal of the filter unit 40 is coupled to the output of the first mixer device 30 for respectively filtering or attenuating the first IF signal and the first IF quadrature signal. The filter device may be, but is not limited to, a polyphase filter and/or a combination of two independent real filters 41 and 42. For the purpose of illustration, the filter device 40 in the present embodiment is shown to be composed of two real filters 41 and 42. These two real filters 41 and 42 are respectively coupled to the output terminals of the first mixer 31 and the first quadrature mixer 32, such that it selectively passes a desired signal or selectively rejects an undesired signal. As such, the real filters 41 and 42 may be band-pass filters or band-reject filters.

The second local signal generation unit 50 generates a second local signal (LO2) and a second quadrature local signal (LO2′), wherein the second local signal (LO2) and the second quadrature local signal (LO2′) have the same amplitude and 90° phase difference.

The second mixer device 60 comprises a second mixer 61, a second quadrature mixer 62, a third mixer 63 and a third quadrature mixer 64. The first input terminals of the second mixer 61 and the second quadrature mixer 62 are coupled to one output terminal of the filter device 40, and the first input terminals of the third mixer 63 and the third quadrature mixer 64 are coupled to another output terminal of the filter device 40. The second input terminals of the second mixer 61 and the third mixer 63 are coupled to the second local signal LO2 of the second local signal generation unit 50. The second input terminal of the second quadrature mixer 62 and the third quadrature mixer 64 are coupled to the second quadrature local signal LO2′ of the second signal generation unit 50. The mixers 61, 62, 63 and 64 respectively mix the first IF signal and the first IF quadrature signal with the second local signal and the second quadrature local signal to produce a second IF signal and a second IF quadrature signal. (Please refer to B′ of FIG. 3 for its spectrum.)

An input terminal of the polyphase filter 70 is coupled to the second mixer device 60 for combining the second IF signal and the second IF quadrature signal, so as to combine them to produce a single output signal, while in this process filtering out the image signal.

In addition, the integrated television tuner of the present invention further comprises a first variable gain amplifier (VGA) 71, a channel select filter (CSF) 72, and a second variable gain amplifier (VGA) 73.

Wherein, the first variable gain amplifier 71 is coupled to the polyphase filter 70 to amplify the combined second IF signal.

The channel select filter 72 is coupled to the first variable gain amplifier 71 to select a predetermined channel signal from the amplified second IF signal.

The second variable gain amplifier 73 is coupled to the channel select filter 72 to further amplify the selected channel signal.

Alternatively, in the integrated television tuner of the present invention, the same result may be achieved by using the channel select filter 72 and the second variable gain amplifier 73 alone, without the first variable gain amplifier 71.

Alternatively, in the integrated television tuner of the present invention, the same result may be achieved by using the first variable gain amplifier 71 and the channel select filter 72 alone, without the second variable gain amplifier 73.

The integrated television tuner with this structure is able to achieve the objectives of enhanced filtering of the image signal. An additional advantage of the integrated television tuner with this structure, is that it reduces the signal strength of unwanted signals, thus lowering the linearity requirements of the second mixer device and the subsequent circuit elements.

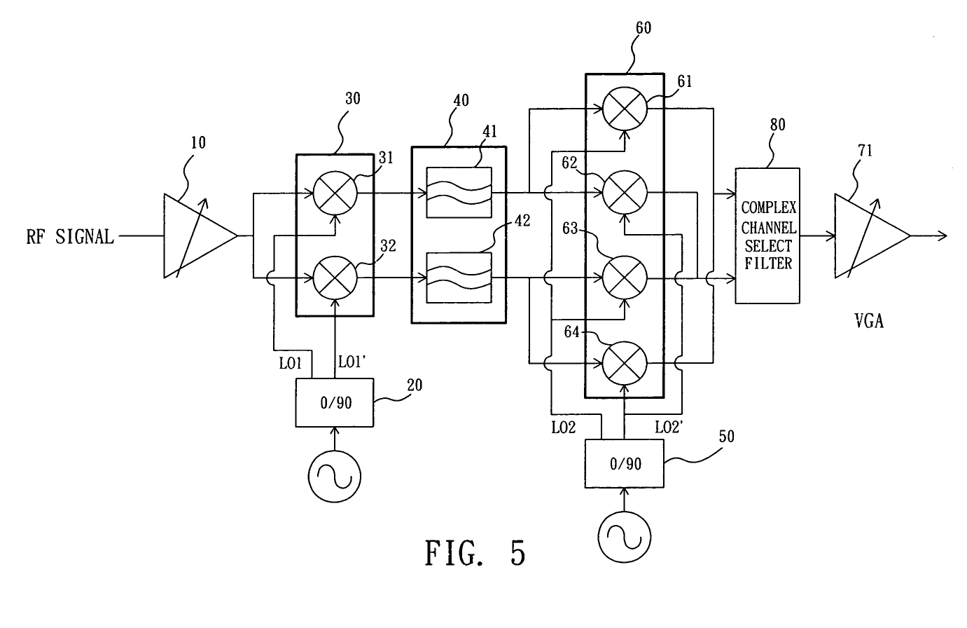

Refer to FIG. 5 for a schematic diagram showing an integrated television tuner according to another preferred embodiment of the present invention. The integrated television tuner of the present invention comprises: a low noise amplifier (LNA) 10; a first local signal generation unit 20; a first mixer device 30; a filter device 40; a second local signal generation unit 50; a second mixer device 60; a complex channel select filter 80; and a first variable gain amplifier 71.

The low noise amplifier (LNA) 10, the first local signal generation unit 20, the first mixer device 30, the filter device 40, the second local signal generation unit 50, the second mixer device 60 and the first variable gain amplifier 71 are the same as the counterparts in FIG. 4 with the same designation numbers.

An input terminal of the complex channel select filter 80 is coupled to the second mixer device 60 for combining the second IF signal and the second IF quadrature signal, in order to produce a single output signal, while in this process selecting a predetermined channel signal and filtering other undesired channel signals and the image signal.

The integrated television tuner with this structure is able to achieve the objectives of enhanced filtering of the image signal. An additional advantage of the integrated television tuner with this structure, is that it reduces the signal strength of unwanted signals, thus lowering the linearity requirements of the second mixer device and the subsequent circuit elements.

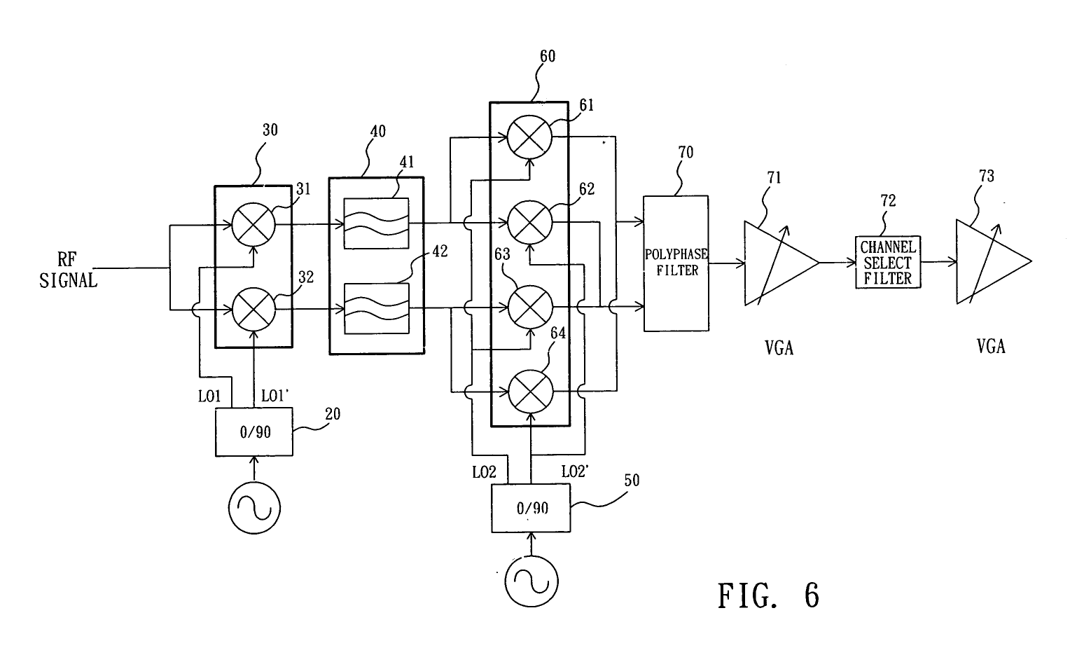

Refer to FIG. 6 for a schematic diagram showing an integrated television tuner according to yet another preferred embodiment of the present invention. The integrated television tuner of the present invention comprises: a first local signal generation unit 20; a first mixer device 30; a filter device 40; a second local signal generation unit 50; a second mixer device 60; and a polyphase filter 70.

In addition, the integrated television tuner of the present invention further comprises a first variable gain amplifier 71, a channel select filter 72, and a second variable gain amplifier 73.

Alternatively, in the integrated television tuner of the present invention, the same result may be achieved by using the channel select filter 72 and the second variable gain amplifier 73 alone, without the first variable gain amplifier 71.

Alternatively, in the integrated television tuner of the present invention, the same result may be achieved by using the first variable gain amplifier 71 and the channel select filter 72 alone, without the second variable gain amplifier 73.

The first local signal generation unit 20, the first mixer device 30, the filter device 40, the second local signal generation unit 50, the second mixer device 60 and the first variable gain amplifier 71 are the same as the counterparts in FIG. 4 with the same designation numbers.

The integrated television tuner with this structure is able to achieve the objectives of enhanced filtering of the image signal. An additional advantage of the integrated television tuner with this structure, is that it reduces the signal strength of unwanted signals, thus lowering the linearity requirements of the second mixer device and the subsequent circuit elements.

Although the invention has been described with reference to a particular embodiment thereof, it will be apparent to those skilled in the art that modifications to the described embodiment may be made without departing from the spirit of the invention. The scope of the invention will be defined by the claims:

What is claimed is:

1. An integrated television tuner, comprising:
a low noise amplifier (LNA), with an input terminal coupled to a RF signal;
a first local signal generation unit, for generating a first local signal and a first quadrature local signal;
a first mixer device, comprising a mixer and a quadrature mixer, wherein the input terminals of said mixer and said quadrature mixer are respectively coupled to said RF signal, and another terminals are coupled to said first local signal generation unit for mixing said RF signal with said first local signal and said first quadrature local signal, so as to generate a first intermediate frequency (IF) signal and a first IF quadrature signal;
a filer unit, with an input terminal coupled to an output of said first mixer device, for respectively filtering or attenuating said first IF signal and said first IF quadrature signal;
a second local signal generation unit, for generating a second local signal and a second quadrature local signal;
a second mixer device, with an input terminal coupled to said filter device and another terminal coupled to said second local signal generation unit for mixing said first IF signal and said first IF quadrature signal with said second local signal and said second quadrature local signal, so as to generate a second IF signal and a second IF quadrature signal; and
a polyphase filter, with an input terminal coupled to said second mixer device for combining said second IF signal and said second IF quadrature signal, so as to generate a real number signal and filter a mirror image signal.

2. The integrated television tuner of claim 1, wherein said filter device may be a polyphase filter.

3. The integrated television tuner of claim 1, wherein said filter device may be composed of two independent real part filters, which are respectively coupled to the output terminals of said mixer and said quadrature mixer to selectively pass a required signal or to selectively filter a nonrequired signal.

4. The integrated television tuner of claim 3, wherein said real part filter may be a band-pass filter or a band-reject or notch filter.

5. The integrated television tuner of claim 1, further comprising:
a first variable gain amplifier (VGA), being coupled to said polyphase filter to magnify said real number signal of said second intermediate frequency; and
a channel select filter (CSF), being coupled to said first variable gain amplifier to receive said real number signal of said second intermediate frequency and to select a predetermined channel signal from said received signal.

6. The integrated television tuner of claim 5, further comprising a second variable gain amplifier, being coupled to said channel select filter to magnify said predetermined channel signal.

7. The integrated television tuner of claim 1, further comprising:
a channel select filter (CSF), being coupled to said polyphase filter to receive a real number signal of said second intermediate frequency and to select a predetermined channel signal from said received signal; and
a first variable gain amplifier (VGA), being coupled to said channel select filter to magnify said predetermined channel signal.

8. An integrated television tuner, comprising:
a low noise amplifier (LNA), with an input terminal coupled to a RF signal;
a first local signal generation unit, for generating a first local signal and a first quadrature local signal;
a first mixer device, comprising a mixer and a quadrature mixer, wherein the input terminals of said mixer and said quadrature mixer are respectively coupled to said RF signal, and another terminals are coupled to said first local signal generation unit for mixing said RF signal with said first local signal and said first quadrature local signal, so as to generate a first intermediate frequency (IF) signal and a first IF quadrature signal;
a filer unit, with an input terminal coupled to an output of said first mixer device, for respectively filtering or attenuating said first IF signal and said first IF quadrature signal;
a second local signal generation unit, for generating a second local signal and a second quadrature local signal;
a second mixer device, with an input terminal coupled to said filter device and another terminal coupled to said second local signal generation unit for mixing said first IF signal and said first IF quadrature signal with said second local signal and said second quadrature local signal, so as to generate a second IF signal and a second IF quadrature signal;
a complex channel select filter, with an input terminal coupled to said second mixer device for respectively filtering said second IF signal and said second IF quadrature signal in order to select a predetermined channel signal and to filter other channel signals and a mirror image signal, so as to generate a real number signal; and
a first variable gain amplifier (VGA), being coupled to a real part channel select filter to magnify said predetermined channel signal.

9. The integrated television tuner of claim 8, wherein said filter device may be a polyphase filter.

10. The integrated television tuner of claim 8, wherein said filter device may be composed of two independent real part filters, which are respectively coupled to the output terminals of said mixer and said quadrature mixer to selectively pass a required signal or to selectively filter a nonrequired signal.

11. The integrated television tuner of claim 10, wherein said real part filter may be a band-pass filter or a band-reject or notch filter.

12. An integrated television tuner, comprising:
a first local signal generation unit, for generating a first local signal and a first quadrature local signal;
a first mixer device, comprising a mixer and a quadrature mixer, wherein the input terminals of said mixer and said quadrature mixer are respectively coupled to a RF signal, and another terminals are coupled to said first local signal generation unit for mixing said RF signal with said first local signal and said first quadrature local signal, so as to generate a first intermediate frequency (IF) signal and a first IF quadrature signal;
a filer unit, with an input terminal coupled to an output of said first mixer device, for respectively filtering or attenuating said first IF signal and said first IF quadrature signal;
a second local signal generation unit, for generating a second local signal and a second quadrature local signal;
a second mixer device, with an input terminal coupled to said filter device and another terminal coupled to said second local signal generation unit for mixing said first IF signal and said first IF quadrature signal with said second local signal and said second quadrature local signal, so as to generate a second IF signal and a second IF quadrature signal; and
a polyphase filter, with an input terminal coupled to said second mixer device for combining said second IF signal and said second IF quadrature signal, so as to generate a real number signal and filter a mirror image signal.

13. The integrated television tuner of claim 12, wherein said filter device may be a polyphase filter.

14. The integrated television tuner of claim 12, wherein said filter device may be composed of two independent real part filters, which are respectively coupled to the output terminals of said mixer and said quadrature mixer to selectively pass a required signal or to selectively filter a nonrequired signal.

15. The integrated television tuner of claim 14, wherein said real part filter may be a band-pass filter or a band-reject or notch filter.

16. The integrated television tuner of claim 12, further comprising:
a first variable gain amplifier (VGA), being coupled to said polyphase filter to magnify said real number signal of said second intermediate frequency; and
a channel select filter (CSF), being coupled to said first variable gain amplifier to receive said real number signal of said second intermediate frequency and to select a predetermined channel signal from said received signal.

17. The integrated television tuner of claim 16, further comprising a second variable gain amplifier, being coupled to said channel select filter to magnify said predetermined channel signal.

18. The integrated television tuner of claim 12, further comprising:
a channel select filter, being coupled to said polyphase filter to receive a real part signal of said second IF signal and said second IF quadrature signal and to select a predetermined channel signal from said received signals; and
a variable gain amplifier (VGA), being coupled to said channel select filter to magnify said predetermined channel signal.

19. The integrated television tuner of claim 12, further comprising:
a complex channel select filter, being coupled to said polyphase filter for respectively filtering said second IF signal and said second IF quadrature signal in order to select a predetermined channel signal and to filter other channel signals and said mirror image signal, so as to generate a real number signal; and
a variable gain amplifier (VGA), being coupled to said complex channel select filter to magnify said predetermined channel signal.
